(19) United States
(12) Patent Application Publication
(10) Pub. No.: US 2026/0210697 A1
(43) Pub. Date: Jul. 23, 2026

(54) METROLOGY SYSTEM WITH CHROMATIC RANGE SENSOR AND COLLISION PROTECTION

(71) Applicant: Mitutoyo Corporation, Kanagawa-ken (JP)

(72) Inventor: Maxwell James PERKINS, Mountlake Terrace, WA (US)

(21) Appl. No.: 19/030,487

(22) Filed: Jan. 17, 2025

(51) Int. Cl. G01B 11/00

(52) U.S. Cl. CPC G01B 11/007

(57) ABSTRACT

A metrology system is provided including a chromatic range sensor optical pen, a measuring machine and an optical pen motion configuration. The optical pen focuses different wavelengths at different distances proximate to a workpiece to be measured. The measuring machine adjusts a relative position between the optical pen and the workpiece (e.g., for utilizing the optical pen for measuring the workpiece). The optical pen motion configuration includes a top portion that is attached to the optical pen and which is configured to move in a positive axial direction (e.g., relative to a holding portion that is attached to the measuring machine), thus enabling the optical pen to move from a rest position (e.g., thus minimizing any potential damage) when a corresponding force in the positive axial direction is applied by a contact (e.g., as corresponding to a collision) of the optical pen with the workpiece or other object.

### BACKGROUND

### Technical Field

The disclosure relates generally to precision measurement instruments, and more particularly to chromatic range sensors such as may be used with measuring machines for determining measurements of workpieces.

### Description of the Related Art

It is known to use chromatic confocal techniques in optical range sensors (e.g., including height, distance, etc., sensors). As described in U.S. Pat. No. 7,876,456 (the '456 patent), which is hereby incorporated herein by reference in its entirety, an optical element having axial chromatic aberration, also referred to as axial or longitudinal chromatic dispersion, may be used to focus a broadband light source such that the axial distance to the focus varies with the wavelength. Thus, only one wavelength will be precisely focused on a surface, and the surface height or distance relative to the focusing element determines which wavelength is best focused. Upon reflection from the surface, the light is refocused onto a small detector aperture, such as a pinhole or the end of an optical fiber. Upon reflection from the surface and passing back through the optical system to the in/out fiber, only the wavelength that is well-focused on the surface is well-focused on the aperture. All of the other wavelengths are poorly focused on the aperture, and so will not couple much power into the fiber. Therefore, for the light returned through the fiber, the signal level will be greatest for the wavelength corresponding to the surface height (i.e., distance) to the surface. A spectrometer-type detector measures the signal level for each wavelength, in order to determine the surface height (e.g., for which the wavelength that is well-focused on the surface will generally form the highest peak in the overall detector signal).

Certain manufacturers refer to practical and compact chromatic range sensor (CRS) systems that operate as described above, and that are suitable for use in an industrial setting, as chromatic point sensors (CPS) or chromatic line sensors, or the like. A compact chromatically-dispersive optical assembly used with such systems is referred to as an “optical pen,” or a “pen.” The CRS optical pen is connected through an optical fiber to an electronic portion of the chromatic range sensor system. The electronic portion includes a light source that transmits light through the fiber to be output from the optical pen, and also provides a spectrometer that detects and analyzes the returned light. The returned light forms a wavelength-dispersed intensity profile received by the spectrometer's detector array. Pixel data corresponding to the wavelength-dispersed intensity profile is analyzed to determine the “dominant wavelength position coordinate” as indicated by a peak or centroid of the intensity profile (e.g., as corresponding to the wavelength that is well-focused on the surface), and the resulting pixel coordinate of the peak and/or centroid is used with a lookup table to determine the distance to the surface. This pixel coordinate may be determined with sub-pixel resolution, and may be referred to as the “distance-indicating coordinate” or “distance indicating pixel coordinate.”

For various metrology applications and systems, it may be desirable to utilize a CRS optical pen in combination with a measuring machine (e.g., a roundness tester, etc.) In various implementations, the CRS optical pen may be coupled to the measuring machine, and the measuring machine may move the CRS optical pen and/or the workpiece in relation to one another for obtaining measurements, and for which various issues (e.g., collisions, etc.) may occur. In relation to such issues, an improved system (e.g., including a CRS optical pen as coupled to a measuring machine) would be desirable.

### BRIEF SUMMARY

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

In accordance with one aspect, a metrology system is provided, including a chromatic range sensor system, a measuring machine and an optical pen motion configuration. The chromatic range sensor system includes a chromatic range sensor optical pen configured to focus different wavelengths at different distances proximate to a surface of a workpiece to be measured. The optical pen is configured to be coupled to the measuring machine in a rest position and the measuring machine is configured to adjust a relative position between the optical pen and a workpiece to be measured. The optical pen motion configuration is configured to enable motion of the optical pen from the rest position when a corresponding force is applied by a contact of the optical pen with the workpiece or other object. The optical pen motion configuration includes a top portion which is configured to be coupled (e.g., fixedly attached) to the optical pen and which is configured to move in a positive axial direction when a corresponding force in the positive axial direction is applied by a contact (e.g., as corresponding to a collision) of the optical pen with the workpiece or other object. In various implementations, the optical pen motion configuration further includes a motion configuration holding portion (e.g., as fixedly attached to the measuring machine), and for which the top portion is coupled to the motion configuration holding portion as part of a kinematic coupling configuration.

In accordance with another aspect, a method is provided for operating the metrology system. The method includes: utilizing the measuring machine to adjust a relative position between the optical pen and a workpiece to be measured; and utilizing the optical pen motion configuration to enable motion of the optical pen from the rest position in a positive axial direction when a corresponding force in the positive axial direction is applied by a contact (e.g., as corresponding to a collision) of the optical pen with the workpiece or other object.

In accordance with another aspect, an optical pen motion configuration is provided for use in a metrology system. The optical pen motion configuration includes a top portion and a motion configuration holding portion. The top portion is configured to be coupled (e.g., fixedly attached) to the optical pen. The top portion is coupled to the motion configuration holding portion (e.g., which may be fixedly attached to the measuring machine) as part of a kinematic coupling configuration and the top portion is configured to decouple from the motion configuration holding portion to enable motion of the optical pen from the rest position in a positive axial direction when a corresponding force in the positive axial direction is applied by a contact (e.g., as corresponding to a collision) of the optical pen with the workpiece or other object.

### BRIEF DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1 is a block diagram of an exemplary chromatic range sensor (CRS) system including an optical pen;

FIG. 2 is a diagram of a system noise (bias) profile from a CRS system illustrating wavelength-dependent voltage offset signal levels for the pixels in a detector array when no measurement surface is present;

FIG. 3 is a diagram of an intensity profile from a CRS system illustrating a valid wavelength peak produced by a wavelength reflected by a surface, wherein the pixel position of the peak corresponds to a measurement distance to the surface;

FIG. 4A is a diagram of a first representation of CRS distance calibration data, which correlates distance-indicating pixel coordinates with known measurement distances to a measured workpiece surface;

FIG. 4B is a diagram of a second representation of CRS distance calibration data, comprising an example CRS distance calibration lookup table, which references distance-indicating coordinates (DIC) to corresponding measurement distances of a CRS system;

FIG. 5A is a perspective view showing an implementation of a measuring system including a measuring machine (e.g., a roundness measuring machine) utilized in conjunction with a CRS system for measuring an object;

FIG. 5B is a block diagram showing a structure of a controlling/processing unit for the measuring machine and CRS system of FIG. 5A;

FIG. 5C is a diagram illustrating a workpiece with a hole to be measured by the measuring machine and CRS system of FIG. 5A;

FIG. 6 is a diagram of an isometric view of the chromatic range sensor optical pen as coupled to a top portion of the optical pen motion configuration;

FIG. 7 is a diagram of a partially cross-sectional side view of a portion of the optical pen motion configuration;

FIG. 8 is a diagram of an isometric view of the top portion in relation to a motion configuration holding portion of the optical pen motion configuration;

FIG. 9A is an isometric view of the arm portion of the measuring machine with the attached motion configuration holding portion and with the top portion coupled thereto;

FIG. 9B is an isometric view of the arm portion of the measuring machine with the attached motion configuration holding portion; and

FIG. 10 is a flow diagram illustrating one embodiment of a general routine for operating a metrology system including an optical pen motion configuration.

### DETAILED DESCRIPTION

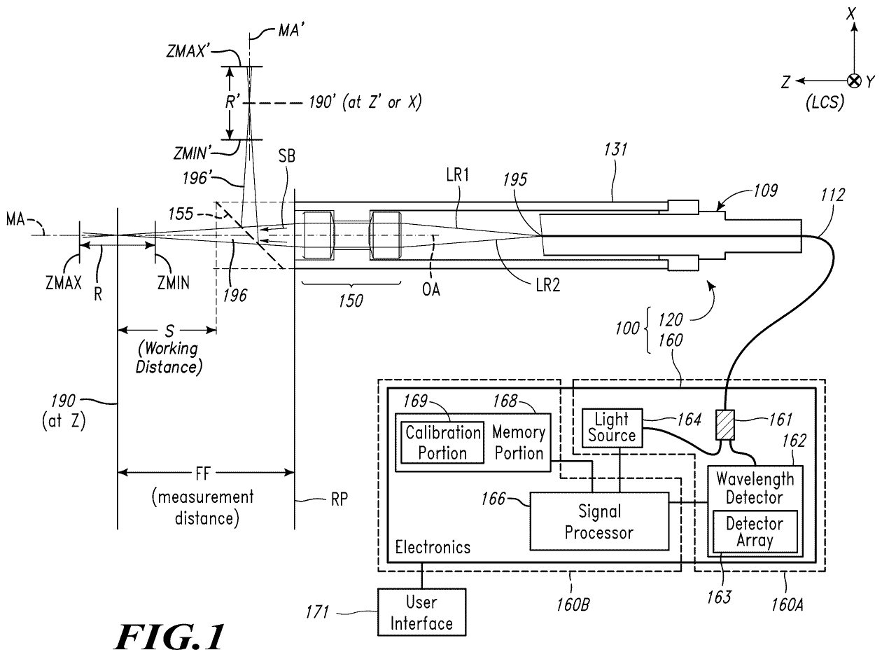

FIG. 1 is a block diagram of an exemplary chromatic range sensor (CRS) system 100 of a first type based on operating principles that are desirable to employ in conjunction with a measuring machine. The CRS system 100 has certain similarities to systems described in U.S. Pat. Nos. 7,876,456; 7,990,522 and 9,329,026 (the '456, '522 and '026 patents, respectively), which are hereby incorporated herein by reference in their entireties. As shown in FIG. 1, the CRS system 100 includes an optical pen 120, an electronics portion 160, and a user interface portion 171. It will be appreciated that the CRS system 100 shown in FIG. 1 is a chromatic point sensor (CPS) system (i.e., for which the CRS optical pen 120 is a chromatic point sensor) which in some instances may measure a single measurement point at a time. However, in various embodiments alternative types of chromatic range sensor systems, such as a chromatic line sensor, may be utilized.

The optical pen 120 includes a fiber optic connector 109, a housing 131 (e.g. an assembly tube), and an optics portion 150. The fiber optic connector 109 is attached to the end of the housing 131. In various implementations, the fiber optic connector 109 may be oriented at an angle relative to the housing 131. The fiber optic connector 109 receives an in/out optical fiber (not shown in detail) through a fiber optic cable 112 which encases it. The in/out optical fiber outputs source light through a fiber aperture 195 and receives reflected measurement signal light through the fiber aperture 195.

In operation, broadband (e.g. white) source light emitted from the fiber end through the fiber aperture 195 is focused by the optics portion 150, which includes a lens or lenses that provide an axial chromatic dispersion, such that the focal point along the optical axis OA is at different distances depending on the wavelength of the light, as is known for chromatic confocal sensor systems. The source light forms a measurement beam 196 that includes a wavelength that is focused on a surface 190 (e.g., a surface of a workpiece, etc.) at a position Z relative to the optical pen 120. Upon reflection from the surface 190, reflected light is refocused by the optics portion 150 onto the fiber aperture 195. The operative source light and reflected light are bounded by the limiting rays LR1 and LR2. Due to the axial chromatic dispersion, only one wavelength will have a front focus dimension FF that matches the measurement distance (e.g., the measurement distance Z) from the optical pen 120 (e.g., from a reference position RP that is fixed relative to the optical pen 120) to the location on the workpiece surface 190. The optical pen is configured such that the wavelength that is best focused at the surface 190 will also be the wavelength of the reflected light that is best focused at the fiber aperture 195. The fiber aperture 195 spatially filters the reflected light such that predominantly the best focused wavelength passes through the fiber aperture 195 and into the core of the optical fiber cable 112. As described in more detail below and in the incorporated references, the optical fiber cable 112 routes the reflected signal light to a wavelength detector 162 that is utilized for determining the wavelength having the dominant intensity, which corresponds to the measurement distance to the surface 190.

FIG. 1 also schematically illustrates an optional reflective element 155 in dashed outline. As described in more detail in U.S. Pat. No. 8,194,251, which is hereby incorporated by reference in its entirety, a reflective element may be placed in the path of the source beam SB. In such an implementation, rather than the measurement axis MA being coaxial with the optical axis OA, the reflective element may direct the measurement beam 196′ along a measurement axis MA′ in a different direction (e.g. orthogonal to the optical axis) as needed in some measurement applications. In such an implementation, the source light forms a measurement beam 196′ that includes a wavelength that is focused on a surface 190′ (e.g., a surface of a workpiece, etc.) at a position (e.g., referenced as a position Z or a position X in some implementations) relative to the optical pen 120. Due to the axial chromatic dispersion, only one wavelength will have a front focus dimension (e.g., a front focus dimension FF′ (not shown) which may be comparable/equal to the front focus dimension FF described above) that matches the measurement distance (e.g., the measurement distance Z′ or X) from the optical pen 120 (e.g., from a reference position RP that is fixed relative to the optical pen 120) to the location on the workpiece surface 190′. More specifically, the front focus dimension and/or the measurement distance Z′ in such a configuration will be understood to be the sum of two distances, including the distance from the reference position RP to the axial position of the reflective element 155, and the distance from the axial position of the reflective element 155 to the workpiece surface 190′ (e.g., for which in the illustrated implementation the two distances are orthogonal to one another). Such an orthogonal orientation is utilized in the embodiments illustrated in other figures herein, as will be described in more detail below. In relation to such implementations, the distance/position Z′ may be simply referenced as a distance/position Z and/or the measurement beam 196′ may be simply referenced as a measurement beam 196, etc.

The electronics portion 160 includes a fiber coupler 161, the wavelength detector 162, a light source 164, a signal processor 166 and a memory portion 168. In various embodiments, the wavelength detector 162 includes a spectrometer or spectrograph arrangement wherein a dispersive optics portion (e.g. a grating) receives the reflected light through the optical fiber cable 112 and transmits the resulting spectral intensity profile to a detector array 163. The wavelength detector 162 may also include related signal processing (e.g. provided by the signal processor 166, in some embodiments) that removes or compensates certain detector-related error components from the profile data. Thus, certain aspects of the wavelength detector 162 and the signal processor 166 may be merged and/or indistinguishable in some embodiments. In various implementations, the signal processor 166 and/or the wavelength detector 162 and/or other signal processors, computing systems, etc., that are utilized for related processing may be referenced as a processing portion of the CRS system 100.

The white light source 164, which is controlled by the signal processor 166, is coupled through the optical coupler 161 (e.g. a 2×1 optical coupler) to the optical fiber cable 112. As described above, the light travels through the optical pen 120 which produces longitudinal chromatic aberration so that its focal length changes with the wavelength of the light. The wavelength of light that is most efficiently transmitted back through the fiber is the wavelength that is in focus on the surface 190 or 190′ at the position Z. The reflected wavelength-dependent light intensity then passes through the fiber coupler 161 again so that approximately 50% of the light is directed to the wavelength detector 162, which may receive a spectral intensity profile distributed over an array of pixels along a wavelength measurement axis of the detector array 163, and operate to provide corresponding profile data as described in more detail in the incorporated references.

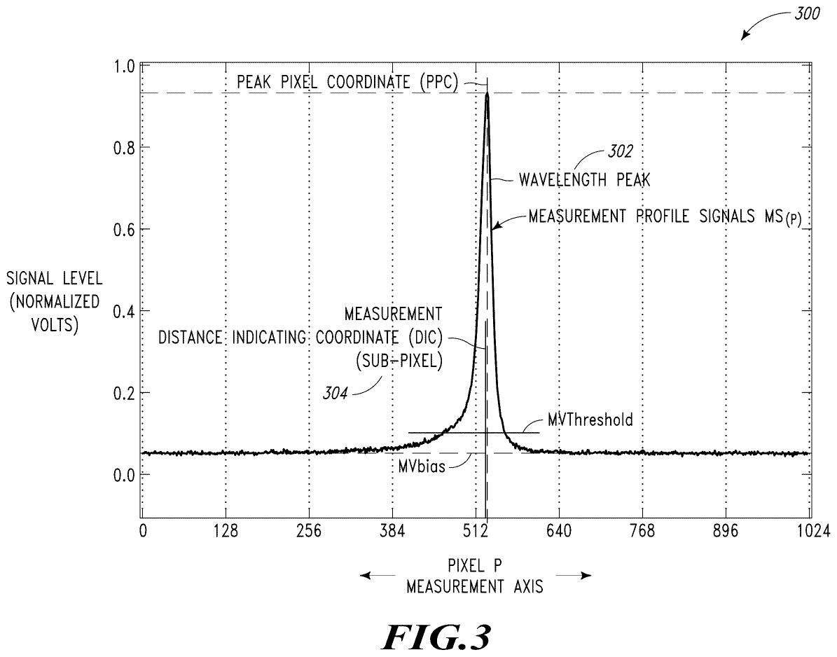

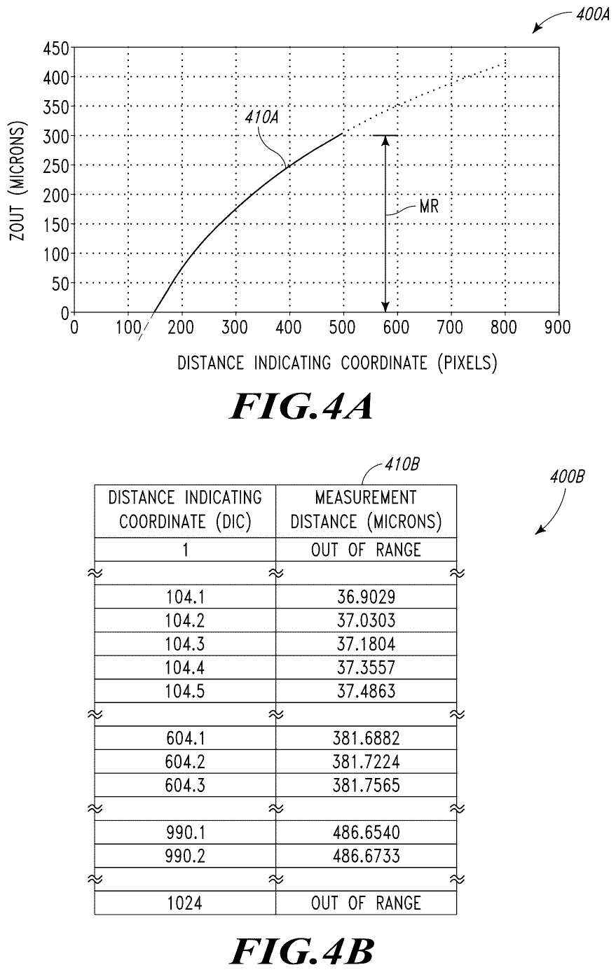

Briefly, the subpixel-resolution distance-indicating coordinate (DIC) of the profile data (e.g., see FIG. 3) is calculated by the signal processor 166, and the DIC (in subpixels) indicates the measurement distance Z to the location on the surface 190 or 190′ (in microns) via a distance calibration lookup table or the like, which is stored in a calibration portion 169 of the memory portion 168, (e.g., as described below with respect to FIGS. 4A, 4B). In accordance with previously known methods, the DIC may be determined by various techniques (e.g., in accordance with the centroid of the intensity profile data included in a peak region, etc.) In various implementations, the profile data may be used to determine the DIC with subpixel resolution, as will be described in more detail below.

The optical pen 120 generally has a measurement range R that is bound by a minimum range distance ZMIN and a maximum range distance ZMAX. The measurement range R in some example instances of known optical pens may be approximately 1/10th of the nominal standoff or working distance from the end of the pen (e.g. in the range of tens of microns to a few millimeters). In various implementations, the measurement range R may also or alternatively be referenced as, and/or may be equal to, a working range (e.g., a working range WR) of the optical pen 120. FIG. 1 schematically illustrates that if the reflector element 155 is used, a measurement range R′ (e.g., which may be equal to the measurement range R) may be directed along a measurement axis MA′ determined by the placement of the reflector element 155. In such a case, the measurement range R′ may be bound by a minimum range distance ZMIN′ and a maximum range distance ZMAX′. In various implementations, the measurement range R′ may also or alternatively be referenced as, and/or may be equal to, a working range (e.g., a working range WR of the optical pen 120). In various implementations, the minimum and maximum range distances ZMIN′ and ZMAX′ may also or alternatively be referenced as simply ZMIN and ZMAX, or XMIN and XMAX (e.g., in accordance with a coordinate system in which the measurement axis MA′ is referenced along an x-axis direction).

It should be appreciated that in some implementations the electronics portion 160 may be located away from the optical pen 120. For example, it has been known to mount an optical pen analogous to the optical pen 120 shown in FIG. 1 on a CMM using a customized bracket, and to route an optical fiber analogous to the optical fiber cable 112 along a makeshift path on the outside of CMM components to a remotely located electronics analogous to the electronics portion 160.

In various implementations, a group of components in a light source and wavelength detector portion 160A (e.g. including the wavelength detector 162 and light source 164) may be included inside an optical probe assembly in some embodiments. A group of components in a measurement signal processing and control circuit 160B (e.g. including the signal processor 166 and memory portion 168) may be located remotely outside of the optical probe assembly, if desired (e.g. to maintain low probe weight and compact probe size).

As further illustrated in FIG. 1, the user interface portion 171 is coupled to the electronics portion 160 and provides a user interface that is configured to receive user input used for the operation of the CRS system 100, such as a user command to select various operating parameters, via any suitable means such as a keyboard, touch sensor, mouse, etc. In exemplary embodiments, the user interface portion 171 may include one or more operation mode selecting elements (e.g., user-selectable buttons) operable by a user to select one of a plurality of operation modes of the CRS system 100 (e.g., a measurement mode, a calibration mode, etc.) The user interface portion 171 is also configured to display information on a screen, such as one or more distances successfully determined/measured by the CRS system 100.

FIG. 1 includes orthogonal XYZ coordinate axes, as a frame of reference (e.g., as part of a local coordinate system (LCS) of the optical pen 120/CRS system 100). The Z direction may be defined to be parallel to the measurement axis MA which is coaxial with the optical axis (OA), which may be a distance measurement axis, of the optical pen 120. As illustrated in FIG. 1, during operation, the surface 190 (e.g., of a workpiece to be measured) is located/placed along the measurement axis MA which is coaxial with the optical axis OA. Alternatively, in an implementation where the reflector element 155 is used, a surface 190′ (e.g., of a workpiece to be measured) is located/placed along the measurement axis MA′. In some such implementations, a Z direction (e.g., as corresponding to a measurement distance Z) may be defined to be parallel to the measurement axis MA′ (e.g., as part of the local coordinate system (LCS) of the optical pen 120/CRS system 100, for which the z-axis and Z direction may be the primary axis/direction of interest in relation to measurements of the optical pen 120, for which the Z direction may correspond to the optical axis of the optical pen 120, which is the distance measurement axis of the optical pen 120).

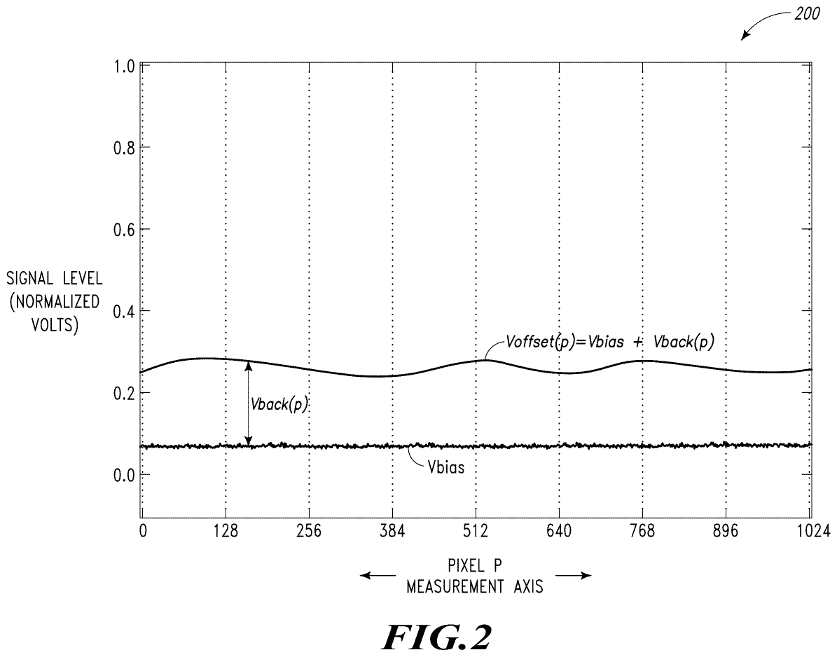

The following description of FIG. 2 outlines certain known background signal processing and/or calibration operations. FIG. 2 is a diagram 200 of a system noise (bias) profile from a CRS system, illustrating voltage offset signal levels Voffset(p) for the pixels in a detector array (see detector array 163 of FIG. 1) when no measurement surface is present within the nominal total measurement range of the CRS system. In such a case, there is no intentionally reflected light and hence no significant or dominant wavelength peak in the resulting intensity profile. The voltage offset signal Voffset(p) is plotted in normalized volts, for each of 1,024 pixels along the wavelength measurement axis of the detector array 163. “Normalized volts” assigns a value of 1.0 to the saturation voltage of the detector array 163. The voltage offset signal Voffset(p) includes a bias signal level Vbias, which is relatively consistent across the detector array, and a background signal component Vback(p), which is shown as varying across the detector array.

The variable background signal Vback(p) represents signals such as background light from wavelength-dependent spurious reflections and the like in the chromatic point sensor, as well as due to the dark current of the various pixels p. In various embodiments, it is advantageous if the signal components Vback(p) (or signals that show the same variation, such as the voltage offset signals Voffset(p)) are stored for calibration or compensation of the pixel array of the detector array 163, and used to compensate all subsequent profile data signals from each pixel p (e.g. by subtraction), on an ongoing basis. Thus, it will be understood that the background signal component Vback(p) is assumed to be compensated in a known manner in various embodiments, and it is not necessary that it be further explicitly considered or described in relation to the various intensity profiles or signal processing operations, or the like, described below.

The following description of FIGS. 3, 4A and 4B outlines certain signal processing operations that determine distance-indicating coordinates (DIC) with subpixel resolution based on valid wavelength peaks produced in wavelength-dispersed intensity profiles from the CRS system and determine measurement distances to surfaces (e.g., in microns) based on the determined DICs. Certain previously known operations outlined here are described in more detail in the '456 patent. The purpose of this description is to provide information which is useful for an overall understanding of certain CRS measurement operations as described herein.

FIG. 3 is a diagram 300 of a wavelength-dispersed intensity profile from a CRS system illustrating a valid wavelength peak 302 produced by a subset of measurement profile signals MS(p) indicative of a wavelength focused on and reflected by a surface (e.g., of a workpiece, etc.) As previously noted, as part of the standard operations for CRS systems, the signal level will be greatest for the wavelength corresponding to the surface height or distance to the surface, for which the wavelength that is well-focused on the surface will generally form the highest peak in the overall detector signal. In the example of FIG. 3, the diagram 300 includes a wavelength peak 302 corresponding to a measured surface. Each of the measurement profile signals MS(p) has the signal level (shown in normalized volts) associated with each pixel p of the detector array (e.g., the detector array 163). The wavelength peak 302 has more than sufficient height (a good signal to noise ratio), is relatively symmetric, and allows a good estimation of the peak location or measurement distance-indicating coordinate (DIC) 304 along the wavelength measurement axis of the detector array. FIG. 3 also shows a bias signal level MVbias (in normalized volts), a peak pixel coordinate (ppc), and a data threshold MVthreshold that defines the lower limit of a distance-indicating subset of measurement profile signals MS(p) forming the wavelength peak 302. All values (e.g., including “MV” values) are in normalized volts.

Briefly, in one embodiment, measurement operations for determining a distance-indicating coordinate (DIC) (in pixels) and determining a corresponding measurement distance (in microns) based on the determined DIC may include the following:
Position the target surface along the optical axis OA, and capture the resulting wavelength-dispersed intensity profile as in the diagram 300. Determine the peak pixel coordinate (ppc), which is the pixel that has the highest signal.
Determine the measurement bias signal level MVbias at a given sampling rate.
Determine the data threshold MVthreshold (e.g., as a percentage of the peak height).
Determine the distance-indicating coordinate (DIC) with sub-pixel resolution, based on the distance-indicating subset of measurement profile signals MS(p) forming the wavelength peak that has a value greater than MVthreshold.
Determine the measurement distance by correlating the DIC with a corresponding distance in the stored distance calibration data (e.g., a distance calibration curve as in FIG. 4A, or a lookup table as in FIG. 4B, etc.).

In the foregoing operations, a DIC may be determined with sub-pixel resolution, based on the distance-indicating subset of measurement profile signals MS(p) above the data threshold MVthreshold. In accordance with previously known methods, a DIC may be determined as the subpixel-resolution coordinate of a centroid X_{C} of the distance-indicating subset of signals MS(p). For example, for a detector with 1024 pixels (i.e., each having a corresponding pixel number (p) from 1 to 1024), the centroid X_{C} may be determined according to:

$$Xc = \frac{{{\sum }_{p = 1}}^{1024} {p ( {S}_{M} ( p ) )}^{n}}{{{\sum }_{p = 1}}^{1024} {( {S}_{M} ( p ) )}^{n}} \qquad ( Eq . 1 )$$

$$where ,$$

$${S}_{M} ( p ) = \{ \begin{matrix}{MS}_{p} - MVThreshold ( p p c ) , & for {MS}_{p} \geq MVThreshold ( p p c ) \\ 0 , & for {MS}_{p} < MVTThreshold ( p p c )\end{matrix} \} \qquad ( Eq . 2 )$$

In one specific example, n=2 in EQUATION 1. It will be appreciated that EQUATION 2 restricts the signals MS(p) used in the centroid calculation to a distance-indicating subset.

FIG. 4A is a diagram 400A of a first representation of CRS measurement distance calibration data 410A which correlates distance-indicating coordinates (DIC) with sub-pixel resolution to known measurement distances (ZOUT) in microns along the optical axis (OA) of the CRS system (e.g., as stored in the calibration portion 169 of FIG. 1). It will be appreciated that the specific values of FIG. 4A are intended to be illustrative only, and may not correspond to specific values indicated in other examples (e.g. in relation to certain values described with respect to FIGS. 1-3 and/or the specific table values of FIG. 4B as will be described in more detail below, although it will be appreciated that the concepts are analogous). The example shown in FIG. 4A is for an optical element (e.g., optical pen) having a nominal total measurement range MR of approximately 300 microns, which corresponds to DICs in the range of approximately 150 pixels-490 pixels. However, the CRS system may be calibrated over a larger pixel range and/or different portion of the detector array 163, if desired. Although the distance calibration data 410A appears to form a smooth curve, it will be appreciated that in some instances the distance calibration data and/or output spectral profile data for a typical CRS system, particularly for economical CRS systems, may exhibit certain short range variations/irregularities (e.g., as described in part in the '456 patent).

One exemplary laboratory calibration method (e.g., as may be utilized for factory calibration, etc.) to determine the CRS measurement distance calibration data 410A and/or 410B employs a mirror (e.g., which in one example implementation may be the surface 190 or 190′ of FIG. 1) moved along the optical axis OA. The displacement of the mirror along the optical axis OA relative to the optical pen may be controlled (e.g., by a stepper motor, etc.) which steps the calibration measurement distance in approximately equal steps (e.g., 0.1 or 0.2 micron steps). For each step, the actual mirror position or displacement is acquired using a reference standard, such as an interferometer. For each actual mirror position, the calibration distance indicating coordinate of the CRS system is determined, based on the corresponding intensity profile data provided by the CRS detector. The calibration distance indicating coordinate and the corresponding actual position are then recorded to provide the distance calibration data 410A and/or 410B.

After the distance calibration data has been determined, during later measurement operations, to determine a measurement distance to a workpiece surface (e.g. surface 190 or 190′ of FIG. 1), the workpiece surface is positioned along the optical axis OA of the CRS optical pen. The measurement distance indicating coordinate of the CRS is determined, based on the measurement DIC determined from the intensity profile data provided by the CRS detector. Then, the distance calibration data (e.g., such as distance calibration data 410A, 410B) is used to determine the CRS measurement distance Z that corresponds to that specific measurement DIC.

FIG. 4B is a diagram 400B of a second representation of CRS distance calibration data 410B comprising a CRS distance calibration lookup table for referencing distance-indicating coordinates to measurement distances for a chromatic point sensor (e.g., as stored in the calibration portion 169 of FIG. 1). As noted above, it will be appreciated that the table values of FIG. 4B are intended to be illustrative only, and may not correspond to specific values indicated in other examples, such as those of FIG. 4A, although for which it will be appreciated that the concepts are analogous. In general, it will be appreciated that a same set of distance calibration data may be represented as both a curve (e.g., as illustrated in FIG. 4A) or a table (e.g., as illustrated in FIG. 4B) and that the distance calibration data utilized to form one such type of representation may similarly be utilized to form the other type of representation and/or other representations.

In FIG. 4B, in the left column the calibration DICs entries cover the pixel coordinates from 1 to 1,024, in increments of 0.1 pixel steps, and in the right column the corresponding measurement distances (in microns) (ZOUT) are entered. In operation, the measurement DIC calculated by the CRS system is referenced to the stored calibration lookup table in order to determine the corresponding measurement distance (in microns). If the measurement DIC falls between adjacent calibration DIC values, then the measurement distance may be determined, for example, by interpolation. In the example of FIG. 4B, some specific example values are shown for some small ranges near DICs with pixel positions of approximately 104, 604 and 990, with corresponding measurement distances in ranges near 37 microns, 381 microns and 486 microns.

In operation (e.g., for a measurement distance to a surface 190 or 190′ as illustrated in FIG. 1), the optical pen 120 is connected to the CRS electronics portion 160 and operably positioned relative to the surface 190 or 190′ to perform measurement operations. The measurement operations include the optical pen 120 inputting an input spectral profile from the illumination source 164 and outputting corresponding radiation to the surface 190 or 190′ and receiving reflected radiation from the surface 190 or 190′ and outputting the reflected radiation to provide an output spectral profile to the CRS wavelength detector 162, which then provides output spectral profile data. The output spectral profile includes a distance-dependent profile component and a distance-independent profile component. The distance-dependent profile component has a wavelength peak (e.g., peak 302 in FIG. 3) that indicates a measurement distance (e.g., measurement distance Z) from the optical pen 120 to the surface 190 or 190′. As described above, the measurement DIC that is determined in accordance with a centroid calculation by the CRS system is referenced to the stored distance calibration data (e.g., FIG. 4A, 4B) in order to determine the measurement distance (e.g., measurement distance Z which is a value ZOUT) corresponding to the measurement DIC. If the measurement DIC falls between adjacent calibration DIC values, then the measurement distance corresponding to the measurement DIC may be determined by interpolation (e.g., between the measurement distances corresponding to the adjacent calibration DIC values).

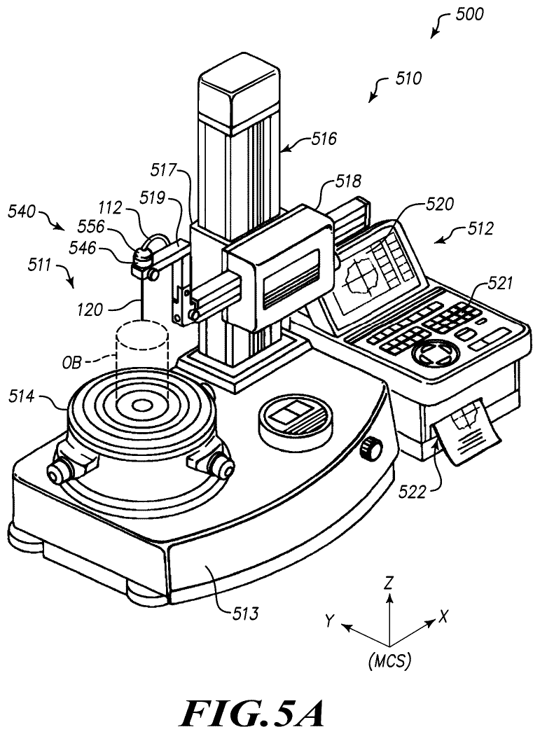

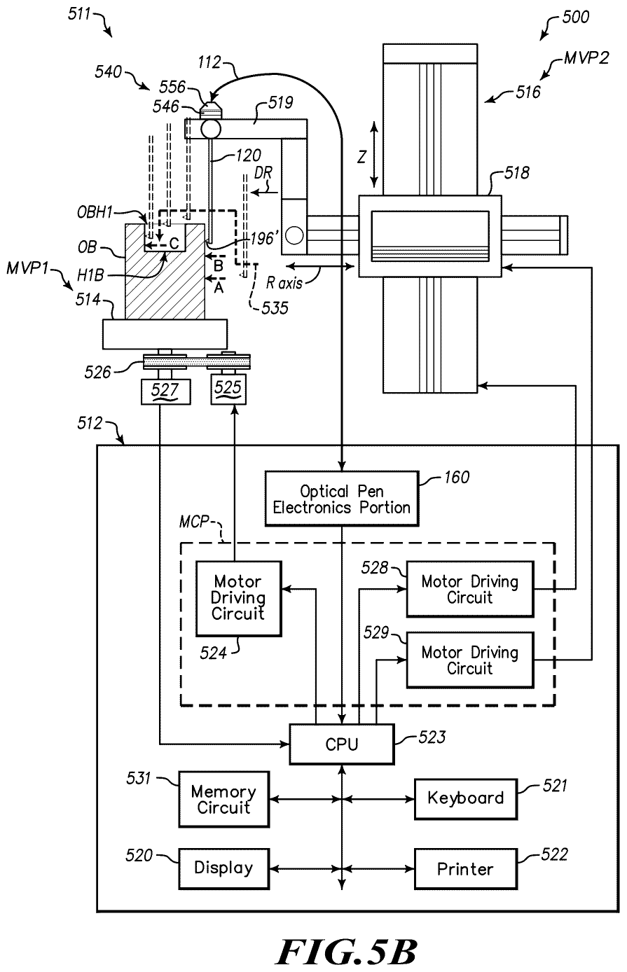

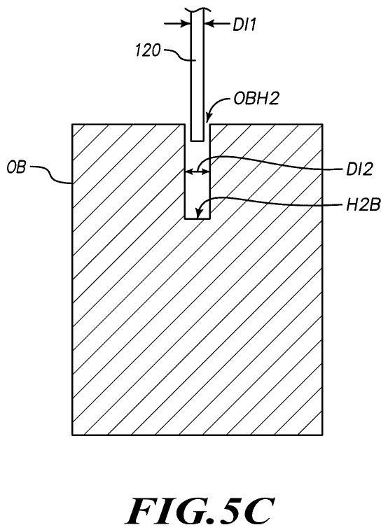

FIG. 5A is a perspective view showing an implementation of a metrology system 500 including a measuring machine 510 utilized in conjunction with a CRS system 100 (i.e., including an optical pen 120) for measuring a workpiece. FIG. 5B is a block diagram showing a structure of a controlling/processing unit 512 for the measuring machine 510 and CRS system 100 (i.e., including an optical pen electronics portion 160) of FIG. 5A. In various implementations, the measuring machine 510 may be a roundness measuring machine (e.g., which in various implementations may also or alternatively be in the form of or otherwise referenced as a roundness tester and/or a cylindrical coordinate measuring machine). The measuring machine 510 comprises a measurement unit 511 for measuring the form of the surface of a workpiece OB, and a controlling/processing unit 512 for controlling the measurement operation of the measurement unit 511 and for processing position data which is obtained through the measurement.

The measurement unit 511 comprises a base 513 fixedly placed on a desired horizontal plane. The base 513 includes a rotary stage 514 (e.g., a rotary table) for rotating the workpiece OB at a constant speed around an axis of rotation (e.g., an axis of measurement) which is perpendicular to the horizontal plane, and a head driving mechanism 516 for moving an optical pen 120 as attached/coupled at an end of an arm portion 519, for detecting the form of the surface of the workpiece OB, within a predetermined plane including the axis of rotation. The head driving mechanism 516 has a Z axis guiding means 517 for guiding the optical pen 120 at the end of the arm portion 519 along the Z axis (e.g., of an XYZ machine coordinate system (MCS) of the measuring machine 510), which is parallel to the axis of rotation, and an R axis guiding means 518 for guiding the optical pen 120 at the end of the arm portion 519 along the R axis, which is a diametrical line passing through the axis of rotation. The optical pen 120 is moved in a direction DR to be proximate to the workpiece OB, such that a surface of the object is within the measuring range R′ of the optical pen 120 (e.g., as described above with respect to FIGS. 1-4B, and for which the surface of the workpiece OB may correspond to the surface 190′ in FIG. 1, etc.). In various implementations, the position of the optical pen 120 may be adjusted so that any variance of the position of the surface of the object (e.g., as it is rotated) will be within the measuring range R′ of the optical pen 120 (e.g., such as may be determined/performed during a setup process which may include rotating the object while measurement signals are received from the optical pen 120 and the position of the optical pen 120 and/or the workpiece is adjusted accordingly, and in certain implementations may include making adjustments such that a center of the measuring range R′ may be approximately positioned at a center of a variance of the position of the surface).

The controlling/processing unit 512 comprises a display 520 for displaying various data, a keyboard 521 through which a user inputs various information, and a printer 522 for printing out data or the like as required. The controlling/processing unit 512 further comprises, as shown in FIG. 5B, a CPU 523 for controlling the operation of the rotary stage 514 and head driving mechanism 516, and for processing the obtained position data through calculation. The CPU 523 outputs a rotary stage driving command, which is supplied to a first motor driving circuit 524 so as to drive a motor 525. The driving force of the motor 525 is transmitted, via a driving force transmission mechanism 526, to the driving axis of the rotary stage 514. The rotation angle of the rotary stage 514 is detected by a rotary encoder 527, which then supplies a rotation angle signal (e.g., in the form of a digital signal) corresponding to the detected rotation angle to the CPU 523.

In various implementations, the CPU 523 adjusts the position of the optical pen 120. When a Z axis driving command from the CPU 523 is supplied to a second motor driving circuit 528, a movement mechanism (e.g., a pulse motor, not shown), which is incorporated in the Z axis guiding means 517, is activated. The driving force of the movement mechanism drives the optical pen 120 along the Z axis so as to position the optical pen 120. When an R axis driving command from the CPU 523 is supplied to a third motor driving circuit 529, a movement mechanism (e.g., a pulse motor, not shown), which is incorporated in the R axis guiding means 518, is activated. The driving force of the movement mechanism drives the optical pen 120 along the R axis so as to position the optical pen 120.

In various implementations, a movement portion MVP1 includes the rotary stage 514, the motor 525, the driving force transmission mechanism 526, and the rotary encoder 527. In various implementations, the movement portion MVP1 is utilized for moving the workpiece OB (e.g., relative to the optical pen 120). In various implementations, a movement portion MVP2 includes the head driving mechanism 516 and an arm portion 519. In various implementations, the movement portion MVP2 is utilized to move the optical pen (e.g., relative to the workpiece OB). In various implementations, a movement control portion MCP includes the motor driving circuits 524, 528 and 529. In various implementations, the movement control portion MCP is utilized to perform relative movement between the optical pen 120 and the workpiece OB (e.g., by controlling the movement portion MVP1 for moving the workpiece OB and/or the movement portion MVP2 for moving the optical pen 120). As will be described in more detail below, the optical pen 120 is coupled to the arm portion 519 by an optical pen motion configuration 540, which includes a motion configuration holding portion 546 and a top portion 556.

The CPU 523 receives, via an optical pen electronics portion 160, a measurement signal (e.g., in the form of a digital signal) from the optical pen 120. In various implementations, an optical fiber (e.g., of an optical fiber cable 112) connects the optical pen 120 to the optical pen electronics portion 160. The received measurement signal from the optical pen electronics portion 160 is stored in a memory circuit 531 along with the rotation angle signal from the rotary encoder 527. The two signals (e.g., digital signals) constitute position data regarding the form of the surface. In various implementations, the stored position data are input to the CPU 523. In various implementations, the CPU 523 may calculate a mean circle according to the known method of least squares or minimum area (zone). The roundness and coaxiality may be calculated based on the calculated mean circle. The result of the calculation may be displayed on the display 520, output via the printer 522, or reported to the outside via a communication line and/or wirelessly, not shown.

Some example standard measuring operations of the measuring machine may be performed as follows (e.g., in this example for measuring the coaxiality of the outer surface as well as the concentricity of the inner and outer surfaces, for a cylinder as a workpiece OB having a hole OBH1 with a bottom H1B and continuous outer and inner surfaces around the axis of rotation). The central axis of the workpiece OB may be manually or automatically coincided with the axis of rotation of the rotary stage 514 in a first step (e.g., utilizing adjustment mechanisms for adjusting the position of the workpiece OB on the rotary stage 514). The operator programs a movement path 535 (see FIG. 5B) of the optical pen 120 via the keyboard 521 in a second step. In this step, attention is required to prevent the optical pen 120 from striking/colliding with the workpiece OB. As part of the movement path, the optical pen 120 is moved to measurement points A and B at third and fourth steps, so that position data is obtained regarding the roundness at the measurement points A and B (e.g., as defined on the outer surface of the workpiece OB). In a fifth step, the optical pen 120 is moved to measurement point C, so that position data is obtained regarding the roundness at the measurement point C which is defined on the inner surface of the workpiece OB (e.g., within a hole OBH1 within the workpiece OB). For the measurements, the coordinates (R,Z) of the measurement points A, B and C may be given the coordinates for an ideal surface of the workpiece OB. Finally in a sixth step, a mean circle may be calculated for each of the measurement points A, B and C on the basis of the obtained position data, utilizing a method of least squares or minimum zone. Using the obtained mean circle as a reference, the coaxiality and concentricity of the workpiece OB may be calculated. In various implementations, the position data of the outer surface and the inner surface may be displayed with both the diameters of the surfaces aligned with each other, for which the concentricity of the inner and outer surfaces and the variation of the thickness of the surface wall can be observed.

For each of the measurement points A, B and C, a similar process is followed for obtaining the position data. For each measurement point, the CPU 523 initially drives the optical pen 120 to the measurement point along the programmed movement path. The CPU 523 then rotates the rotary stage 514 at a constant speed. The rotation angle of the rotary stage 514 is detected by the rotary encoder 527, and is input as a rotation angle signal to the CPU 523 at an equal interval. The optical pen 120 outputs a measurement signal for every output of the rotation angle signal for an input to the CPU 523. The CPU 523 stores the rotation angle signal and the measurement signal in the memory circuit 531 as position data. This process is performed for the measurement point A, and then is repeated for the measurement points B and C.

Those skilled in the art will appreciate that the controlling/processing unit 512 and/or the CPU 523, etc., may generally be implemented using any suitable computing system or device, including distributed or networked computing environments, and the like. Such computing systems or devices may include one or more general-purpose or special-purpose processors (e.g., non-custom or custom devices) that execute software to perform the functions described herein. Software may be stored in memory (e.g., memory circuit 531), such as random-access memory (RAM), read-only memory (ROM), flash memory, or the like, or a combination of such components. Software may also be stored in one or more storage devices, such as optical-based disks, flash memory devices, or any other type of non-volatile storage medium for storing data. Software may include one or more program modules that include routines, programs, objects, components, data structures, and so on that perform particular tasks or implement particular abstract data types. In distributed computing environments, the functionality of the program modules may be combined or distributed across multiple computing systems or devices and accessed via service calls, either in a wired or wireless configuration.

FIG. 5C is a diagram illustrating a workpiece OB with a relatively narrow hole OBH2 to be measured by the metrology system 500 of FIG. 5A. For measuring such a narrow diameter hole OBH2, it will be appreciated that the optical pen 120 must have a sufficiently small diameter DI1 to fit within the relatively small diameter DI2 of the hole OBH2. As will be described in more detail below, one issue with respect to measuring such relatively small diameter holes, is that it may be relatively difficult (e.g., for a user or measuring machine, etc.) to know/see the exact bottom of the small diameter hole (e.g., to be able to detect how deep the small diameter hole is), although for which it may be desirable for the optical pen 120 to be inserted as far down as possible (e.g., to take measurements near or at the bottom H2B of the small diameter hole OBH2). Such factors may increase the possibility of a collision occurring (e.g., as the optical pen 120 is lowered down into the small diameter hole OBH2, and for which there is a possibility/concern of the distal end of the optical pen 120 colliding with the bottom H2B of the small diameter hole OBH2). This may be especially true for applications where it is desirable for inspection processes to be performed relatively quickly (e.g., for which there may be relatively fast movements of the optical pen 120, such as for being inserted down into the hole OBH2). It is noted that similar collisions may occur between the distal end of the optical pen 120 and the bottom H1B of the hole OBH1 as illustrated and described above with respect to FIG. 5B.

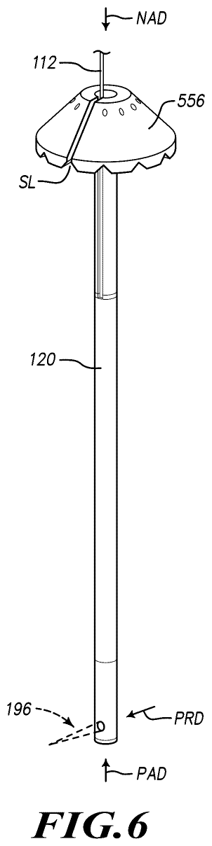

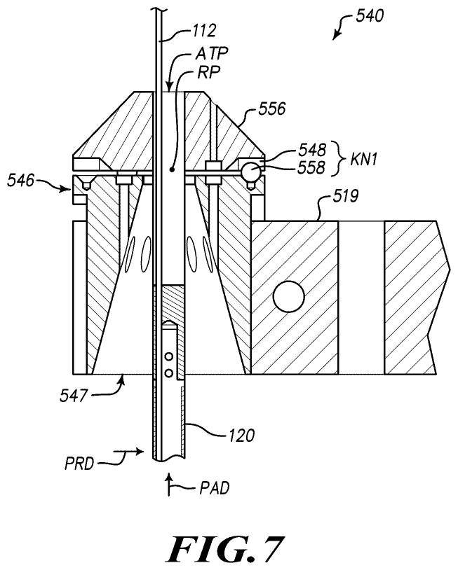

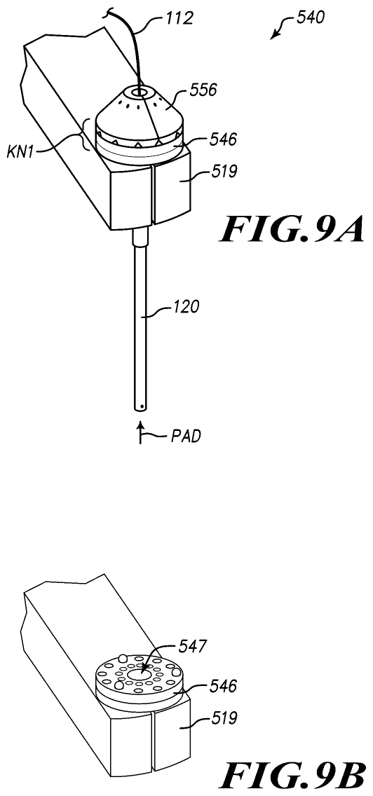

As will be described in more detail below with respect to FIGS. 6-10, the metrology system 500 according to exemplary embodiments includes an optical pen motion configuration 540 configured to enable motion of the optical pen 120 from a rest position RP (e.g., see FIGS. 7 and 9A) when a corresponding force is applied by a contact (e.g., as corresponding to a collision) of the optical pen 120 with the workpiece OB or other object. As noted herein, such a contact (e.g., as corresponding to a collision) may result from movement of the optical pen 120 by the measuring machine 510, such as utilizing the movement control portion MCP, which causes the optical pen 120 to contact (e.g., collide with) the workpiece OB or other object, such as contacting (e.g., colliding with) a bottom H1B or H2B of a hole OBH1 or OBH2 of a workpiece OB.

The optical pen motion configuration 540 is thus useful, for example, for collision protection (e.g., to reduce or eliminate potential damage to the optical pen 120 as caused by a collision between the optical pen 120 and the workpiece OB or other object). As described herein, without the utilization of the optical pen motion configuration 540, such contact may otherwise be more likely to cause damage to the optical pen 120 (e.g., as may be relatively expensive and may have certain fragile aspects). Still further, such collisions may otherwise have damaging effects on the structure, alignment and/or calibration of the CRS system 100, optical pen 120 and/or measuring machine 510.

It will be appreciated that in certain prior systems, a probe or stylus has typically been attached with no compliance for moving from a rest position RP in a positive axial direction when a contact (e.g., as a result of a collision with the workpiece or other object) occurred. In some such prior systems, a stylus has been attached with a “breakaway” configuration, enabling a stylus to simply separate and fall away from the measuring machine/probe toward the stage or ground, which would be relatively damaging to an optical pen 120 if a similar configuration was utilized. In comparison, it is noted that the optical pen motion configuration 540 as described herein does not enable the optical pen 120 to separate and fall away from the measuring machine, and for which at least part of the optical pen 120 remains within an aperture 547 of the holding portion 546 (e.g., and for which even if the optical pen 120 begins to tilt it will continue to be held/supported by the holding portion 546, such as with the optical pen 120 contained by/resting against the edge(s) of the aperture 547).

As an example of a type of use for which an optical pen motion configuration 540 as described herein may be particularly beneficial, for certain applications an optical pen 120 may be utilized to measure an inner surface/diameter of a relatively small diameter hole (e.g., as described above with respect to FIG. 5C). As noted above, for such uses, the optical pen must be of sufficiently small diameter to fit within the relatively small diameter hole. Due to such requirements and the corresponding small dimensions, the optical pen 120 may have a relatively thin casing and other structures with reduced dimensions, which may be more fragile or otherwise susceptible to being damaged (e.g., deformed, etc.) when a contact (e.g., due to a collision) occurs. In addition, for such relatively small diameter holes, it may be relatively difficult (e.g., for a user or measuring machine) to know/see the exact bottom of the small diameter hole (e.g., to be able to detect how deep the small diameter hole is), although for which it may be desirable for the optical pen 120 to be inserted as far down as possible (e.g., to take measurements near or at the bottom of the small diameter hole). It is further noted that due to the orientation of the measuring beam 196′ (e.g., as directed at a 90 degree angle or otherwise to the side), the optical pen 120 may not be able to sense a bottom (e.g., H1B or H2B) of a hole (e.g., as the distal end of the optical pen 120 approaches the bottom of the hole).

Such factors may increase the possibility of a collision occurring (e.g., as the optical pen 120 is lowered down into the small diameter hole, and for which there is a possibility/concern of the distal end of the optical pen 120 colliding with the bottom of the small diameter hole). This may be especially true for applications where it is desirable for inspection processes to be performed relatively quickly (e.g., with corresponding rapid movements of the optical pen 120, etc.). In the event of such a contact/collision, the optical pen motion configuration 540 as described herein enables the optical pen 120 to move in the positive axial direction from a rest position (e.g., relative to the arm portion 519 of the measuring machine 510) so as to reduce/minimize the possibility of damage to the optical pen 120. In addition, during normal measurement operations, the optical pen motion configuration 540 maintains the optical pen 120 in a desired precise position and orientation (e.g., in relation to the arm portion 519 of the measuring machine 510) as is beneficial/required for the highly precise measurement operations that are performed utilizing the optical pen 120, as described herein.

With respect to the measurement operations, as described above with respect to FIGS. 5A and 5B, the measuring machine 510 may move the optical pen 120 and/or the workpiece OB (e.g., utilizing the movement control portion MCP) so as to adjust a relative position between the optical pen 120 and the workpiece OB (e.g., for enabling/utilizing the optical pen 120 for scanning or otherwise measuring a surface/feature of the workpiece OB, such as a surface or diameter of a hole in the workpiece, etc.). As described herein, the optical pen motion configuration 540 may be configured such that the optical pen 120 is configured to be in a rest position RP (e.g., relative to a motion configuration holding portion 546, or the arm portion 519, or other reference portion of the optical pen motion configuration 540 or measuring machine 510, etc.) when a sufficient corresponding force is not applied by a contact (e.g., as corresponding to a collision) with the workpiece OB or other object (e.g., the stage 514, etc.) to move the optical pen 120 from the rest position RP.

More specifically, as will be described in more detail below, as part of the optical pen motion configuration 540, the top portion 556 (e.g., which in certain implementations may also or alternatively be referenced as a “cap portion”) is fixedly attached to the optical pen 120, and the motion configuration holding portion 546 (e.g., which in certain implementations may also or alternatively be referenced as a “base portion”) is fixedly attached to the measuring machine 510 (e.g., to the arm portion 519 of the measuring machine). In various implementations, the top portion 556 is coupled to the motion configuration holding portion 546 by a kinetic coupling configuration KN1 (i.e., thus coupling the optical pen 120 to the measuring machine 510), with the optical pen 120 in the rest position RP. When a contact (e.g., as corresponding to a collision) occurs, the optical pen 120 may be pushed upwards, thus causing the top portion 556 (i.e., which is fixedly attached to the optical pen 120) to decouple from the motion configuration holding portion 546, thus enabling the optical pen 120 to continue to move upwards (e.g., away from the rest position) without resistance, thus preventing or reducing possible damage to the optical pen 120 as may have otherwise occurred due to the collision. It will be appreciated that if the optical pen motion configuration 540 was not included (e.g., if the optical pen 120 was rigidly coupled or otherwise attached to the measuring machine such that upward movement of the optical pen 120 was not enabled and/or was otherwise inhibited by elements above the optical pen 120), the risk of damage to the optical pen 120 (e.g., in the event of a contact such as a collision) would correspondingly be increased.

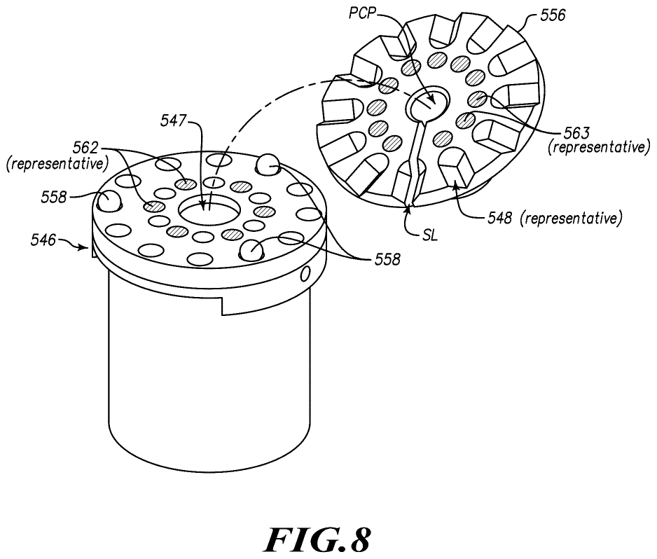

FIG. 6 is a diagram of an isometric view of the chromatic range sensor optical pen 120 as coupled (e.g., rigidly attached) to a top portion 556 of the optical pen motion configuration 540. FIG. 7 is a diagram of a partially cross-sectional side view of a portion of the optical pen motion configuration 540. FIG. 8 is a diagram of an isometric view of the top portion 556 in relation to a motion configuration holding portion 546 of the optical pen motion configuration. FIGS. 9A and 9B are isometric views of an end of the arm portion 519 of the measuring machine 510 (e.g., of FIGS. 5A and 5B) with the rigidly attached motion configuration holding portion 546 and with the top portion 556 coupled thereto (see FIG. 9A) and decoupled therefrom (see FIG. 9B).

As illustrated in FIGS. 6-9B (e.g., and in particular in FIGS. 6, 7 and 9A), the optical pen motion configuration 540 is configured to enable motion of the optical pen 120 from a rest position RP (e.g., see FIG. 7 illustrating an example reference position RP) in a positive axial direction PAD (e.g., a movement in relation to the motion configuration holding portion 546) when a corresponding force in the positive axial direction PAD is applied by a contact (e.g., for which such a contact may be with the workpiece OB as illustrated in FIGS. 5B and 5C, the stage 514, or other object). The optical pen motion configuration 540 is also configured to enable motion of the optical pen 120 from the rest position RP (e.g., enabling motion of a distal end of the optical pen 120) in a perpendicular direction PRD (e.g., which is perpendicular to the positive axial direction PAD, see FIGS. 6 and 7) when a corresponding force in the perpendicular direction PRD is applied by a contact (e.g., for which such a contact may be with the workpiece OB as illustrated in FIGS. 5A and 5B, the stage 514, or other object).

In various implementations, any reference point (e.g., near a proximal end of the optical pen 120 as illustrated in the example of FIG. 7, or near a distal end of the optical pen 120, or other location, etc.) on the optical pen 120 may be utilized for indicating when the optical pen is in, or moved from, a rest position (e.g., the current coordinates of the reference point may be either at, or different than, the coordinates of the corresponding reference position). Similarly, any reference point on any other component of the optical pen motion configuration 540 may be utilized for indicating when that component is in, or moved from, a rest position of that component (e.g., the current coordinates of the reference point may be either at, or different than, the coordinates of the corresponding reference position). In various implementations, coordinates of a rest position (e.g., rest position RP) may be in a coordinate system that may be in relation to part of the motion configuration holding portion 546, or other reference portion of the optical pen motion configuration 540 and/or measuring machine 510 (e.g., on the arm portion 519), etc.

In the example of FIG. 7, the rest position RP is indicated as being along a central axis and just above the motion configuration holding portion 546 (i.e., and is at a fixed position in relation to the motion configuration holding portion 546). In this example, when the reference point (i.e., not shown, but which is fixed on the optical pen 120 and is at the same location as the reference position RP in the illustration of FIG. 7) is moved from/not at the reference position RP (e.g., and correspondingly when the top portion 556 is moved away from or otherwise in relation to the motion configuration holding portion 546), this corresponds to a movement of optical pen 120 from the rest position RP. As noted above, similar reference points and rest positions may be designated for other components (e.g., in relation to a reference point on the top portion 556 moving in relation to a reference position as located on or in relation to the motion configuration holding portion 546, etc.)

In various implementations, the optical pen motion configuration 540 is further configured such that the optical pen 120 may move/may be moved (e.g., by a force of gravity, or as moved by a user, etc.) in a negative axial direction NAD and/or in a direction opposite to the perpendicular direction PRD, to move the optical pen 120 back to the rest position RP when the optical pen 120 is moved away from the workpiece OB or other object with which contact was made (i.e., when the contact ceases). In various implementations, the positive and negative axial directions PAD and NAD may be generally parallel to the Z-axis, and the perpendicular direction PRD may generally lie within an XY plane (e.g., in relation to a local coordinate system (LCS) such as that illustrated in FIG. 1). As will be described in more detail below, in various implementations, certain forces (e.g., gravity, etc.) and/or a retention configuration (e.g., comprising magnets, etc.) may provide a force or forces to maintain the optical pen 120 in the rest position RP (i.e., during normal operating conditions for measurements, etc.) until a contact (e.g., as corresponding to a collision) occurs. In accordance with principles as described herein, it may be desirable for the components to be configured such that any such forces will be small enough that the optical pen 120 is enabled to move upward (e.g., away from the rest position) when a contact (e.g., as corresponding to a collision) occurs without causing damage to the optical pen 120.

In various implementations, the top portion 556 comprises a pen coupling portion PCP (e.g., see FIG. 8) which is configured to be rigidly coupled and/or otherwise rigidly attached to the optical pen 120, specifically, to an attachment portion ATP (e.g., see FIG. 7) of the optical pen. In various implementations, the pen coupling portion PCP may include a hole with a securing element or other configuration capable of receiving and fixedly holding the attachment portion ATP of the optical pen 120. Various types of such coupling configurations are known in the art.

In various implementations, the optical pen 120 is configured to be in the rest position RP (e.g., relative to the motion configuration holding portion 546 or other reference portion) when a sufficient corresponding force is not applied by a contact (e.g., as corresponding to a collision) with a workpiece OB or other object (e.g., such as the stage 514, etc.) to move the optical pen 120 (i.e., which is a non-contact sensor) from the rest position RP. In certain examples, the rest position RP may be in relation to a reference point (not shown) near a proximal end of the optical pen 120, such that if the optical pen is moved (e.g., if a distal end of the optical pen 120 is moved) in the positive axial direction PAD and/or the perpendicular direction PRD (i.e., in relation to the motion configuration holding portion 546 and/or a part of the measuring machine 510, such as the arm portion 519, etc.), the reference point (e.g., of the optical pen 120) will no longer be at the corresponding rest position RP. In relation to the illustrated local coordinate system (LCS) of FIG. 1, movement in the positive axial direction PAD and the negative axial direction NAD generally indicate movement primarily parallel with the Z axis, and movement in the perpendicular direction PRD generally indicates movement primarily in the X axis and/or Y axis directions.

In various implementations, as partially illustrated in FIGS. 7, 8, 9A and 9B, the top portion 556 is coupled to the motion configuration holding portion 546 as part of a kinematic coupling configuration KN1, for which the optical pen motion configuration 540 comprises the kinematic coupling configuration KN1. Such a kinematic coupling configuration is generally designed to exactly constrain two mating parts, providing precision and location certainty. One type of kinematic coupling configuration is a Maxwell kinematic coupling configuration, which in various implementations may be utilized for the kinematic coupling configuration KN1. Such a Maxwell kinematic coupling configuration has three radial V-shaped grooves (oriented relative to a center of a part) in one part that mate with three curved surfaces (e.g., of balls, hemispheres, spherical portions, etc.) in another part. Each curved surface when mated with a V-shaped groove has two contact points for a total of six contact points, enough to constrain all six of the part's degrees of freedom. This design benefits from symmetry and therefore can take advantage of easier manufacturing techniques. Also, the Maxwell coupling is thermally stable due to its symmetry, as the curved surfaces can expand or contract in unison in the V-shaped grooves.

In various implementations, the kinematic coupling configuration KN1 (e.g., a Maxwell kinematic coupling configuration) comprises a set of three radial V-shaped grooves 548 (see FIGS. 7 and 8) disposed at an interval of 120 degrees in the circumferential direction in one part (e.g., in the top portion 556) that mate with a set of three curved surfaces 558 (e.g., surfaces of respective balls) disposed at an interval of 120 degrees in the circumferential direction in another part (e.g., in the motion configuration holding portion 546). In the example of FIG. 8, while the motion configuration holding portion 546 has the three curved surfaces 558, the top portion 556 has more radial V-shaped grooves 548 than just three that mate with the three curved surface 558. In various implementations, the additional radial V-shaped grooves 548 may be included to enable the measurement beam 196′ of the optical pen 120 (e.g., see FIGS. 1 and 6) to be oriented in different directions for different measurement operations. More specifically, in the example of FIG. 8, the top portion 556 is shown to include/have twelve radial V-shaped grooves 548 disposed at an interval of 30 degrees in the circumferential direction. In accordance with this configuration, once the optical pen 120 is fixedly attached to the top portion 556, there are options to couple the top portion 556 to the motion configuration holding portion 546 in different orientations (e.g., at 30 degree rotations relative to one another, with the measurement beam 196′ oriented in correspondingly different directions).

When assembled/coupled, the curved surfaces 558 of the balls rest in the corresponding V-shaped grooves 548 of the top portion 556. In various implementations, when there is contact (e.g., of the distal end of the optical pen 120) in the perpendicular direction PRD (e.g., with a perpendicular direction PRD illustrated in FIGS. 6 and 7) with resulting motion in the X and/or Y axis directions, the top portion 556 may tilt/pivot in relation to the holding portion 546. For example, one or two of the V-shaped grooves 548 of the kinematic coupling configuration KN1 may be tilted up away from the corresponding curved surfaces 558 while the other one or two V-shaped grooves 548 may remain with their corresponding contact with the curved surfaces 558 as the pivot point(s).

According to the exemplary configurations and assemblies described above, the kinematic coupling configuration KN1 achieves high positioning reproducibility of the top portion 556 (and thus the optical pen 120) with respect to the motion configuration holding portion 546. Such characteristics are desirable in high precision metrology systems configured to determine measurements in the micron or sub-micron range, for example. In some such implementations, the optical pen 120 may have certain characteristics for which the high positioning reproducibility is related to the high accuracy measurements. As an example, the optical pen 120 may in some instances have certain characteristics that may be addressed by calibration or other techniques, which in some instances may be based at least in part on the angular or other orientation of the optical pen 120. In general, the high positioning reproducibility for the optical pen 120 helps ensure the high precision measurements of the system.

In various implementations, a retention configuration (e.g., comprising retention components 562, 563) may be utilized to provide a retention force to help retain the top portion 556 in a fixed position in relation to the motion configuration holding portion 546 (e.g., during normal measurement operations). In the example of FIG. 8, retention components 562 (e.g., magnets) are shown in the motion configuration holding portion 546, and retention components 563 (e.g., magnets) are shown in the top portion 556. The retention components 562 and the retention components 563 provide an attractive retention force with respect to each other, which helps retain the top portion 556 in a fixed position and orientation in relation to the motion configuration holding portion 546.

In accordance with principles as described herein, in various implementations it may be desirable for the retention components 562 and 563 to be configured such that a “breakaway” force (i.e., as required to separate the retention components 562 from the retention components 563) is small enough so as to enable the optical pen 120 to move upward when a contact (e.g., as corresponding to a collision) occurs without causing damage to the optical pen 120. In the example of FIG. 8, there are twelve retention components 563 in the top portion 556, arranged in 30 degree increments (e.g., similar to the twelve radial V-shaped grooves 548), and there are six retention components 562 in the motion configuration holding portion 546, arranged in 60 degree increments. This corresponds to a total of six retention component pairs providing attractive retention force, although it will be appreciated that in alternative configurations there may be more (e.g., twelve, etc.) or fewer (e.g., three, etc.) retention component pairs for providing the attractive retention force. It will be appreciated that such retention configurations may be utilized to provide a distributed and balanced attractive force between the kinematic components regardless of rotational mounting orientation.

In various implementations, the optical pen 120 is configured to be coupled to the metrology system and oriented with an optical axis OA (e.g., see FIG. 1) of the optical pen 120 parallel to a z-axis of the metrology system (e.g., as illustrated in FIG. 5B). In various implementations, the optical pen 120 is configured to be moved by the metrology system 500 in a downward direction (e.g., utilizing the at least part of the movement control portion MCP, such as the driving circuit 528, for controlling a movement portion, such as the movement portion 517). In certain circumstances, such downward movement may cause the optical pen 120 to contact (e.g., collide with) a workpiece OB or other object (e.g., the stage 514). This results in a force in the positive axial direction PAD to the optical pen 120, for which the optical pen motion configuration 540 enables motion of the optical pen 120 from the rest position RP in the positive axial direction PAD (e.g., in relation to the motion configuration holding portion 546 and arm portion 519 of the measuring machine 510, etc.).

As illustrated in FIGS. 7, 8 and 9B, the motion configuration holding portion 546 comprises an aperture 547 (e.g., a hole) which at least part of the optical pen 120 extends down through when the top portion 556 is coupled to the motion configuration holding portion 546. In various implementations, at least part of the optical pen 120 moves upward in the aperture 547 when there is motion of the optical pen 120 from the rest position RP in the positive axial direction when a corresponding force is applied by a contact (e.g., as corresponding to a collision) of the optical pen 120 with the workpiece or other object. In various implementations, at least part of the aperture 547 (e.g., a distal end of the aperture) has a diameter that is at least 10% larger, or at least 25% larger, than the diameter of the optical pen 120 (e.g., so as to enable movement of a distal end of the optical pen in a perpendicular direction PRD that is perpendicular to the positive axial direction PAD, to move the optical pen from the rest position when a corresponding force in the perpendicular direction is applied by the contact with the workpiece or other object).

For example, as illustrated in FIG. 7, the aperture 547 is a conical shaped hole (e.g., with a larger diameter at the bottom than the top, so as to enable the optical pen 120 to tilt when there is contact in the perpendicular direction PRD with resulting motion of the distal end of the optical pen 120 in the X and/or Y axis directions). In various implementations, the optical pen motion configuration 540 is configured such that as part of a replacement process, the optical pen 120 is slid up out through the aperture 547, and a replacement optical pen is slid down through the aperture 547 until a top portion 556 (e.g., which may be the same top portion 556 or a different top portion 556) that is fixedly attached to the replacement optical pen is coupled to the motion configuration holding portion 546, with the replacement optical pen correspondingly in a rest position RP.

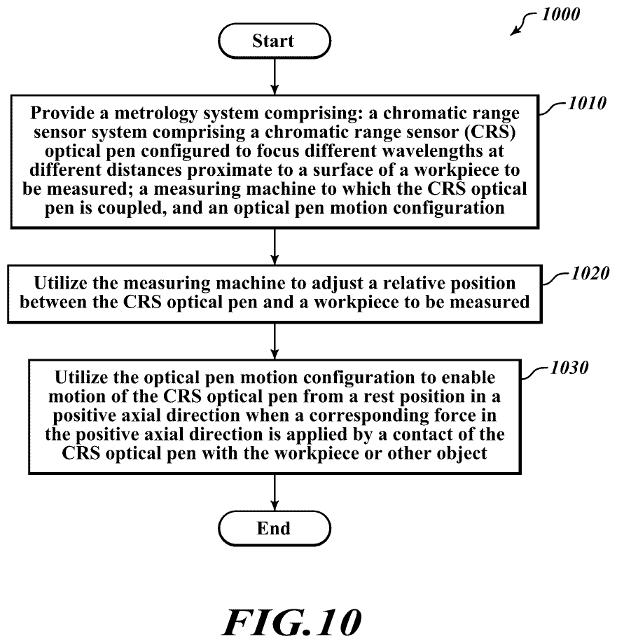

FIG. 10 is a flow diagram illustrating one embodiment of a general routine 1000 for operating a metrology system including an optical pen motion configuration. At a block 1010, a metrology system is provided comprising: a chromatic range sensor system comprising a chromatic range sensor (CRS) optical pen configured to focus different wavelengths at different distances proximate to a surface of a workpiece to be measured; a measuring machine to which the CRS optical pen is coupled, and an optical pen motion configuration. At a block 1020, the measuring machine is utilized to adjust a relative position between the CRS optical pen and a workpiece to be measured. At a block 1030, the optical pen motion configuration is utilized to enable motion of the CRS optical pen from a rest position in a positive axial direction when a corresponding force in the positive axial direction is applied by a contact (e.g., as corresponding to a collision) of the CRS optical pen with the workpiece or other object.

The following describes various exemplary embodiments of the present disclosure with various features and elements annotated with reference numerals found in FIGS. 1-10. It should be understood that the reference numerals are added to indicate exemplary embodiments, and the features and elements are not limited to the particular embodiments illustrated in FIGS. 1-10.

As described herein, a metrology system 500 is provided including a chromatic range sensor optical pen 120, a measuring machine 510 and an optical pen motion configuration 540. The optical pen 120 focuses different wavelengths at different distances proximate to a workpiece OB to be measured. The measuring machine 510 is configured to adjust a relative position between the optical pen 120 and the workpiece OB (e.g., for utilizing the optical pen for measuring the workpiece). The optical pen motion configuration 540 includes a top portion 556 that is coupled (e.g., fixedly attached) to the optical pen 120 and which is configured to move in a positive axial direction PAD (e.g., relative to a holding portion 546 that is attached to the measuring machine 510, such as attached to an arm portion 519 of the measuring machine), thus enabling the optical pen 120 to move from a rest position RP (e.g., thus minimizing any potential damage to the optical pen 120) when a corresponding force in the positive axial direction PAD is applied by a contact (e.g., as corresponding to a collision) of the optical pen 120 with the workpiece OB or other object.

In various implementations, the top portion 556 (e.g., as fixedly attached to the optical pen 120) is coupled to the motion configuration holding portion 546 (e.g., as fixedly attached to the measuring machine) as part of a kinematic coupling configuration KN1. In various implementations, the top portion 556 (e.g., in accordance with the operations of the kinematic coupling configuration KN1) is further configured to tilt to enable movement of a distal end of the optical pen 120 in a perpendicular direction PRD that is perpendicular to the positive axial direction PAD, to move the optical pen 120 from the rest position RP when a corresponding force in the perpendicular direction PRD is applied by the contact (e.g., as corresponding to a collision) with the workpiece OB or other object. In various implementations, the top portion 556 comprises a pen coupling portion PCP which is configured to be rigidly attached to an attachment portion ATP of the optical pen.

As noted above, in various implementations the optical pen motion configuration 540 comprises the kinematic coupling configuration KN1. In various implementations, the kinematic coupling configuration KN1 is configured to decouple in a positive axial direction PAD when a corresponding force in the positive axial direction is applied by a contact (e.g., as corresponding to a collision) of the optical pen 120 with the workpiece OB or other object. In various implementations, the kinematic coupling configuration comprises a set of radial V-shaped grooves 548, which are disposed in one part of the optical pen motion configuration (e.g., in the top part 556), that mate with a set of three curved surfaces 558, which are disposed at an interval of 120 degrees in the circumferential direction in another part (e.g., in the holding portion 546) of the optical pen motion configuration 540.

In various implementations, as part of an adjusting of the relative position between the optical pen 120 and the workpiece OB (e.g., for utilizing the optical pen 120 for measuring the workpiece OB), the measuring machine 510 is configured to move the optical pen 120 in a downward direction which may cause a contact (e.g., as corresponding to a collision) with the workpiece OB or other object, which results in a force in a positive axial direction PAD to the optical pen. In such a circumstance, the optical pen motion configuration 540 enables motion of the optical pen 120 from the rest position RP in the positive axial direction PAD. In various implementations, a movement of the optical pen 120 from the rest position RP corresponds to a movement of the optical pen 120 in relation to the motion configuration holding portion 546 of the optical pen motion configuration 540.

As noted above, in various implementations the optical pen motion configuration 540 includes the motion configuration holding portion 546 as coupled (e.g., fixedly attached) to the measuring machine, and the top portion 556 which is coupled (e.g., fixedly attached) to the optical pen 120 is configured to move in relation to the motion configuration holding portion 546 (e.g., in accordance with the kinematic coupling configuration KN1) to thereby enable motion of the optical pen 120 from the rest position RP when a corresponding force is applied by a contact (e.g., as corresponding to a collision) of the optical pen 120 with the workpiece OB or other object. In various implementations, the optical pen motion configuration 540 further includes an optical pen retention configuration comprising one or more retention components 562, 563 that are configured to provide a retention force to retain the top portion 556 in a fixed position in relation to the motion configuration holding portion 546. In various implementations, each retention component of the one or more retention components comprises a magnet.

In various implementations, the motion configuration holding portion comprises an aperture 547 (e.g., a hole) which at least part of the optical pen 120 extends down through when the top portion 556 is coupled to the motion configuration holding portion 546 (e.g., in accordance with the kinematic coupling configuration KN1). In various implementations, at least part of the optical pen 120 moves upward in the aperture 547 when there is motion of the optical pen 120 from the rest position RP when a corresponding force is applied by a contact (e.g., as corresponding to a collision) of the optical pen 120 with the workpiece OB or other object in the positive axial direction PAD. In various implementations, at least part of the aperture 547 (e.g., at a distal end of the aperture) has a diameter that is at least 25% larger than a diameter of the optical pen 120, so as to enable movement of a distal end of the optical pen 120 in a perpendicular direction PRD that is perpendicular to the positive axial direction PAD, to move the optical pen 120 from the rest position RP when a corresponding force in the perpendicular direction PRD is applied by the contact (e.g., as corresponding to a collision) with the workpiece OB or other object.

In various implementations, the optical pen motion configuration 540 is configured such that as part of a replacement process, the optical pen 120 is slid up out through the aperture 547, and a replacement optical pen is slid down through the aperture 547 until a top portion 556 that is coupled (e.g., fixedly attached) to the replacement optical pen is coupled to the motion configuration holding portion 546 (e.g., as part of a kinematic coupling configuration KN1), with the replacement optical pen correspondingly in a rest position RP. It will be appreciated that in various implementations the optical pen motion configuration 540 and the measuring machine 510 do not include any fixed components or structures above the top portion 556 that would inhibit or otherwise provide a resistive force against the top portion 556 being moved upward (e.g., for removing the optical pen 120 as part of a replacement process and/or in relation to the top portion 556 moving upward when a contact such as a collision occurs between the optical pen 120 and a workpiece OB or other object).

As noted above, in various implementations the optical pen motion configuration 540 is provided for use in a metrology system. The optical pen motion configuration comprises the motion configuration holding portion 546 and the top portion 556. The top portion 556 is configured to be coupled (e.g., fixedly attached) to the optical pen 120. The top portion 556 is coupled to the motion configuration holding portion 546 as part of the kinematic coupling configuration KN1. The top portion 556 is configured to decouple from the motion configuration holding portion 546 (e.g., in accordance with the operations of the kinematic coupling configuration KN1) to enable motion of the optical pen 120 from the rest position RP in a positive axial direction PAD when a corresponding force in the positive axial direction is applied by a contact (e.g., as corresponding to a collision) of the optical pen 120 with the workpiece OB or other object.

While preferred implementations of the present disclosure have been illustrated and described, numerous variations in the illustrated and described arrangements of features and sequences of operations will be apparent to one skilled in the art based on this disclosure. Various alternative forms may be used to implement the principles disclosed herein. In addition, the various implementations described above can be combined to provide further implementations. All of the U.S. patents and U.S. patent applications referred to in this specification are incorporated herein by reference, in their entirety. Aspects of the implementations can be modified, if necessary to employ concepts of the various patents and applications to provide yet further implementations.

These and other changes can be made to the implementations in light of the above detailed description. In general, in the following claims, the terms used should not be construed to limit the claims to the specific implementations disclosed in the specification and the claims, but should be construed to include all possible implementations along with the full scope of equivalents to which such claims are entitled.

1. A metrology system, comprising:
a chromatic range sensor system comprising a chromatic range sensor optical pen configured to focus different wavelengths at different distances proximate to a surface of a workpiece to be measured;
a measuring machine, wherein the optical pen is configured to be coupled to the measuring machine in a rest position and the measuring machine is configured to adjust a relative position between the optical pen and a workpiece to be measured; and
an optical pen motion configuration configured to enable motion of the optical pen from the rest position when a corresponding force is applied by a contact of the optical pen with the workpiece or other object, the optical pen motion configuration comprising a top portion which is configured to be coupled to the optical pen and which is configured to move in a positive axial direction when a corresponding force in the positive axial direction is applied by a contact of the optical pen with the workpiece or other object.

2. The system of claim 1, wherein:
the optical pen motion configuration further comprises a motion configuration holding portion; and
the top portion is coupled to the motion configuration holding portion as part of a kinematic coupling configuration.

3. The system of claim 1, wherein the top portion is further configured to tilt to enable movement of a distal end of the optical pen in a perpendicular direction that is perpendicular to the positive axial direction, to move the optical pen from the rest position when a corresponding force in the perpendicular direction is applied by the contact with the workpiece or other object.

4. The system of claim 1, wherein the top portion comprises a pen coupling portion which is configured to be rigidly attached to an attachment portion of the optical pen.

5. The system of claim 1, wherein the optical pen motion configuration comprises a kinematic coupling configuration.

6. The system of claim 5, wherein the kinematic coupling configuration is configured to decouple in a positive axial direction when a corresponding force in the positive axial direction is applied by a contact of the optical pen with the workpiece or other object.

7. The system of claim 5, wherein the kinematic coupling configuration comprises a set of radial V-shaped grooves, which are disposed in one part of the optical pen motion configuration, that mate with a set of three curved surfaces, which are disposed at an interval of 120 degrees in the circumferential direction in another part of the optical pen motion configuration.

8. The system of claim 1, wherein as part of an adjusting of the relative position between the optical pen and the workpiece, the measuring machine is configured to move the optical pen in a downward direction which may cause a contact with the workpiece or other object, which results in a force in a positive axial direction to the optical pen, for which the optical pen motion configuration enables motion of the optical pen from the rest position in the positive axial direction.

9. The system of claim 1, wherein a movement of the optical pen from the rest position corresponds to a movement of the optical pen in relation to a motion configuration holding portion of the optical pen motion configuration.

10. The system of claim 1, wherein:
the optical pen motion configuration further comprises a motion configuration holding portion; and
the top portion which is coupled to the optical pen is configured to move in relation to the motion configuration holding portion to thereby enable motion of the optical pen from the rest position when a corresponding force is applied by a contact of the optical pen with the workpiece or other object.

11. The system of claim 10, wherein the optical pen motion configuration further comprises an optical pen retention configuration comprising one or more retention components that are configured to provide a retention force to retain the top portion in a fixed position in relation to the motion configuration holding portion.

12. The system of claim 11, wherein each retention component of the one or more retention components comprises a magnet.

13. The system of claim 10, wherein the motion configuration holding portion comprises an aperture which at least part of the optical pen extends down through when the top portion is coupled to the motion configuration holding portion.

14. The system of claim 13, wherein at least part of the optical pen moves upward in the aperture when there is motion of the optical pen from the rest position when a corresponding force is applied by a contact of the optical pen with the workpiece or other object in the positive axial direction.

15. The system of claim 13, wherein at least part of the aperture has a diameter that is at least 25% larger than a diameter of the optical pen, so as to enable movement of a distal end of the optical pen in a perpendicular direction that is perpendicular to the positive axial direction, to move the optical pen from the rest position when a corresponding force in the perpendicular direction is applied by the contact with the workpiece or other object.

16. The system of claim 13, wherein the optical pen motion configuration is configured such that as part of a replacement process, the optical pen is slid up out through the aperture, and a replacement optical pen is slid down through the aperture until a top portion that is coupled to the replacement optical pen is coupled to the motion configuration holding portion, with the replacement optical pen correspondingly in a rest position.

17. The system of claim 10, wherein the motion configuration holding portion is coupled to the measuring machine.

18. A method for operating a metrology system,
the metrology system comprising:
a chromatic range sensor system comprising a chromatic range sensor optical pen configured to focus different wavelengths at different distances proximate to a surface of a workpiece to be measured;
a measuring machine, wherein the optical pen is configured to be coupled to the measuring machine in a rest position; and
an optical pen motion configuration that is configured to enable motion of the optical pen from the rest position when a corresponding force is applied by a contact of the optical pen with the workpiece or other object, the optical pen motion configuration comprising a top portion which is configured to be coupled to the optical pen;
the method comprising:
utilizing the measuring machine to adjust a relative position between the optical pen and a workpiece to be measured; and
utilizing the optical pen motion configuration to enable motion of the optical pen from the rest position in a positive axial direction when a corresponding force in the positive axial direction is applied by a contact of the optical pen with the workpiece or other object.

19. An optical pen motion configuration for use in a metrology system,
the metrology system comprising:
a chromatic range sensor system comprising a chromatic range sensor optical pen configured to focus different wavelengths at different distances proximate to a surface of a workpiece to be measured; and
a measuring machine, wherein the optical pen is configured to be coupled to the measuring machine in a rest position; and
the optical pen motion configuration comprising:
a top portion which is configured to be coupled to the optical pen; and
a motion configuration holding portion, wherein the top portion is coupled to the motion configuration holding portion as part of a kinematic coupling configuration and the top portion is configured to decouple from the motion configuration holding portion to enable motion of the optical pen from the rest position in a positive axial direction when a corresponding force in the positive axial direction is applied by a contact of the optical pen with the workpiece or other object.

20. The optical pen motion configuration of claim 19, wherein the top portion is further configured to tilt to enable movement of a distal end of the optical pen in a perpendicular direction that is perpendicular to the positive axial direction, to move the optical pen from the rest position when a corresponding force in the perpendicular direction is applied by the contact with the workpiece or other object.
